(19) United States
(12) Patent Application Publication
(10) Pub. No.: US 2026/0139657 A1
(43) Pub. Date: May 21, 2026

(54) METHOD AND DEVICE FOR CONVERTING WIND ENERGY INTO ELECTRICAL ENERGY

(71) Applicant: SkySails Power GmbH, Hamburg (DE)

(72) Inventor: Jan Kapala, Hamburg (DE)

(21) Appl. No.: 18/706,258

(22) PCT Filed: Oct. 26, 2022
(86) PCT No.: PCT/EP2022/079881

§ 371 Date: Apr. 30, 2024

(30) Foreign Application Priority Data
Nov. 2, 2021 (EP) 21206024.8

(51) Int. Cl. F03D 5/00; H02K 7/18; H02K 16/00

(52) U.S. Cl. CPC F03D 5/015; H02K 7/183; H02K 16/005; F05B 2220/706; F05B 2240/9172

(57) ABSTRACT

Method for converting wind energy into electrical energy, in which, in a first phase (25) of an operating cycle, a kite (14) is used to exert a tractive force upon a traction-cable winch (16), and the tractive force is converted into a driving force for an electrical machine (17), such that the electrical machine (17) generates electrical energy, and in which, in a second phase (26) of the operating cycle, the electrical machine (17) is used to drive the traction-cable winch (16) to reel-in the traction cable (15). The electrical machine (17) comprises a first rotor (29), a second rotor (30) that interacts electrically with the first rotor (29), and an axial portion in which the magnetic components of the first rotor (29) overlap with the magnetic components of the second rotor (30). The first rotor (29) is mechanically coupled to the traction-cable winch (16). In the second phase (26) of the operating cycle, kinetic energy of the second rotor (30) is used to drive the traction-cable winch (16). The invention also relates to a corresponding device.

### BACKGROUND

The invention relates to a method and a device for converting wind energy into electrical energy. In the method, in a first phase of an operating cycle, a kite is used to exert a tractive force upon a traction-cable winch, and the tractive force is converted into a driving force for an electrical machine, such that the latter generates electrical energy. In a second phase of the operating cycle, the electrical machine is used to drive the traction-cable winch to reel-in the traction cable.

In this method, the electrical machine is operated as a generator in the first phase of the operating cycle. The electrical machine is thus supplied with mechanical energy that can be converted into electrical energy. In the second phase of the operating cycle, the electrical machine is motor-operated. The electrical machine thus provides a driving force by which the traction-cable winch is driven to reel-in the traction cable. A surplus of electrical energy available, for example, for feeding into a transmission network results when more energy is supplied to the electrical machine in the first phase of the operating cycle than is extracted in the second phase of the operating cycle. The problem arises that, when the electrical machine switches between generator and motor operation, losses can occur that have a negative effect on the efficiency of the method.

### SUMMARY

The invention is based on the object of presenting a highly efficient method and device for converting wind energy into electrical energy. Proceeding from the stated prior art, the object is achieved by the features of the independent claims. Advantageous embodiments are specified in the dependent claims.

In the method according to the invention, the electrical machine comprises a first rotor, a second rotor that interacts electrically with the first rotor, and an axial portion in which the magnetic components of the first rotor overlap with the magnetic components of the second rotor. The first rotor is mechanically coupled to the traction-cable winch. In the second phase of the operating cycle, kinetic energy of the second rotor is used to drive the traction-cable winch.

The invention is based on the concept that, by suitable control of the electrical machine, the torque transmitted between the first rotor and the second rotor can be adjusted largely irrespective of the mechanical movement of the rotors relative to each other. It is therefore possible to extract kinetic energy from one rotor and use it to supply kinetic energy to the other rotor. This possibility is used in the second phase of the operating cycle to apply a driving force for the traction-cable winch by use of kinetic energy from one rotor.

The method may be conducted in such a way that all the energy required in the second phase of the operating cycle to reel-in the traction cable is extracted from kinetic energy of the second rotor. Similarly, it is possible to extract only a portion of the energy required in the second phase of the operating cycle from kinetic energy of the second rotor, while another portion of the energy is supplied from another source. For example, the electrical machine may be supplied with electrical energy from an energy storage device or an electrical power network, which is converted by means of the electrical machine into a driving force for the traction-cable winch.

An operating cycle refers to a sequence that extends from the beginning of a paying-out operation to the end of the immediately following reeling-in operation. In a regular operating cycle, the traction cable is reeled-in by the reeling-in operation to the same length as it was at the beginning of the paying-out operation. The subsequent paying-out operation then begins with the same traction-cable length as the previous paying-out operation. The term operating cycle is not limited to regular operating cycles. It is also possible for the traction-cable length at the end of the reeling-in operation to be greater or less than at the beginning of the previous paying-out operation. By being able to variably select the traction-cable length both at the beginning of a paying-out operation and at the beginning of a reeling-in operation, it is possible to react flexibly to changing operating conditions such as, for example, altered wind conditions or altered requirements in the network feed-in.

The direction of rotation of the first rotor is directly coupled to the operating cycle. When the traction cable is paid out in the first phase of the operating cycle, the first rotor rotates in one direction. When the traction cable is reeled-in in the second phase of the operating cycle, the first rotor rotates in the opposite direction.

In the case of the second rotor, there is no such direct link between the phases of the operating cycle and the direction of rotation. Electrical torque can be transmitted between the first rotor and the second rotor irrespective of how the first rotor and the second rotor rotate relative to each other. In the method, there may be portions of the first phase of the operating cycle in which the first rotor and the second rotor have the same direction of rotation. Similarly, there may be phases in which the first rotor and the second rotor rotate in opposite directions. Phases in which the second rotor is at rest relative to the housing of the electrical machine are also possible. In the second phase of the operating cycle, the same applies to the rotational movement of the rotors relative to each other.

In the case of the electrical machine, at least one of the rotors is an externally excited rotor. A shaft of the externally excited rotor may be provided with slip rings, via which the rotor may be electrically excited. The device may comprise a first converter, via which an electrical signal suitable for excitation is supplied to the rotor.

The other rotor of the electrical machine may comprise a permanent magnet. In this case, external electrical excitation may not be required. In one embodiment, the other rotor is also an externally excited rotor, which may be electrically controlled via slip rings. The device may comprise a second converter in order to enable this rotor also to be supplied with an electrical signal suitable for excitation.

The direction of rotation of the first rotor reverses during an operating cycle, such that the first rotor is braked and accelerated in the course of an operating cycle. In order to keep the energy required for deceleration and acceleration low, it is advantageous if the first rotor has a lesser mass. On the other hand, a high mass is advantageous for the second rotor, because in this way more kinetic energy can be stored in the form of rotational energy. The mass of the second rotor may be higher than the mass of the first rotor, preferably higher at least by a factor of 2, further preferably higher at least by a factor of 5, further preferably higher at least by a factor of 10. A shaft located between the electrical machine and the traction-cable winch is not in this sense included in the mass of the first rotor. On the other hand, the mass of the second rotor includes all elements that rotate together with the second rotor.

The electrical machine comprises an axial portion in which the magnetic components of the first rotor overlap with the magnetic components of the second rotor. In other words, there is a radial lobe, extending from the axis of the electrical machine, that intersects the first rotor and the second rotor. With respect to this portion, the first rotor may be realized as an internal rotor and the second rotor as an external rotor. The design of the second rotor as an external rotor is advantageous because the moving mass is at a greater distance from the axis of rotation, and thus contributes to a greater extent to the moment of inertia of the second rotor. A reversed design is also possible, in which the second rotor is realized as an internal rotor and the first rotor as an external rotor. The electrical machine may comprise a housing extending around the first and the second rotor.

A shaft may extend between the traction-cable winch and the electrical machine, mechanically connecting the two components to each other. Also possible is a transmission located between the traction-cable winch and the electrical machine. The traction-cable winch may be axially spaced apart from the electrical machine. In another embodiment, the electrical machine and the traction-cable winch form an integrated component. In particular, a drum of the traction-cable winch, onto which the traction cable is wound, may overlap axially with the first rotor of the electrical machine. A direct connection between the first rotor and a rotary drum located radially outside the first rotor is possible if the first rotor forms the external rotor of the electrical machine.

To increase the potential for storing kinetic energy in the form of rotational energy, the second rotor may be provided with a centrifugal mass that does not contribute to the electromagnetic interaction with the first rotor. The centrifugal mass may be located in a different axial portion of the electrical machine than the magnetic components of the second rotor. The centrifugal mass may be located inside or outside a housing of the electrical machine. A bearing may be located between the centrifugal mass and the magnetic components of the second rotor to mount the second rotor relative to a frame of the electrical machine. The centrifugal mass may constitute at least 50 %, preferably at least 70 %, more preferably at least 80 % of the total mass of the second rotor.

The mounting of the electrical machine may be configured in such a way that the second rotor is mounted so as to be rotatable relative to a frame of the electrical machine, and that the first rotor is mounted so as to be rotatable relative to the second rotor. The reverse configuration is also possible, in which the first rotor is mounted so as to be rotatable relative to the frame of the electrical machine, and the second rotor is mounted so as to be rotatable relative to the first rotor. A shaft that mechanically connects the first rotor to the traction-cable winch may extend between the first rotor and the traction-cable winch.

A control unit that controls the interaction of the components may be provided. The control unit may be configured to send control signals to a nacelle of the kite, to steer the kite along predefined flight paths. The control signals may be used to alter the length of control lines of the kite in order to influence the direction of flight of the kite.

The control unit may additionally be configured to provide control signals to set the electrical excitation of the first rotor and/or the electrical excitation of the second rotor. The control signals may each go to a converter assigned to the rotor, via which the appropriate electrical signals are sent to the respective rotor.

The control unit may control the electrical machine, in particular the magnetic components of the first rotor and/or the second rotor, in such a way that the second rotor is accelerated in the first phase of the operating cycle. In particular, in the first phase of the operating cycle, an amount of kinetic energy may be stored in the second rotor sufficient to reel-in the traction cable to the initial position for the start of a subsequent regular operating cycle. It is also possible for the control unit to control the electrical machine in such a way that, in the first phase of the operating cycle, an amount of kinetic energy is stored in the second rotor that is less than the energy required to reel-in the traction cable, and that electrical energy is supplied from an external source for the purpose of reeling-in the traction cable.

Further, the control unit may control the electrical machine in such a way that the energy feed-in is adjusted to the requirements of the transmission network. Short-term phases of an excessively high energy feed-in may be counteracted by accelerating the second rotor. Short-term phases of insufficient energy feed-in may be counteracted by extracting kinetic energy from the second rotor. Contributions to short-term stabilisation of the transmission network may also be made by extracting kinetic energy from the second rotor and feeding it into the transmission network, or alternatively by supplying kinetic energy to the second rotor and extracting it from the transmission network. The control unit may process locally obtained input information in order to adapt the energy feed-in to the requirements of the transmission network. The locally obtained input information may be, for example, sensor data from the electrical machine or the traction-cable winch. It is also possible for the control unit to process externally generated input information such as, for example, a control input received from the transmission network.

The invention also relates to a device for converting wind energy into electrical energy. The device comprises a kite, a traction-cable winch and a traction cable that extends between the traction-cable winch and the kite. A control unit controls the kite and the electrical machine. The traction-cable winch is coupled to an electrical machine such that, when operating as a generator, the electrical machine is driven by a force acting upon the traction cable to generate electrical energy, and such that, when operating as a motor, the traction-cable winch is driven by the electrical machine to reel-in the traction cable. The electrical machine comprises a first rotor and a second rotor that interacts electrically with the first rotor. The electrical machine comprises an axial portion in which the magnetic components of the first rotor overlap with the magnetic components of the second rotor.

The control unit may control the kite, in a first phase of an operating cycle, in such a way that the kite exerts a tractive force upon the traction cable, and the electrical machine is driven by the tractive force. In a second phase of an operating cycle, the control unit may control the electrical machine in such a way that the electrical machine drives the traction-cable winch by extracting kinetic energy from the second rotor.

The device may be enhanced by further features, described in connection with the method according to the invention. The method may be enhanced by further features, described in connection with the device according to the invention.

### BRIEF DESCRIPTION OF THE DRAWINGS

The invention is described in the following, by way of example, with reference to the accompanying drawings and on the basis of advantageous embodiments. In the drawings:

FIG. 1: shows a schematic representation of a device according to the invention;

FIG. 2: shows a schematic representation of an operating state of the device from FIG. 1;

FIG. 3: shows a schematic representation of an operating cycle of the device from FIG. 1;

FIG. 4: shows the energy balance during the cycle from FIG. 3;

FIG. 5: shows a schematic representation of components of the device from FIG. 1;

FIG. 6: shows a schematic representation of the electrical machine from FIG. 5;

FIG. 7: shows a section along line A-A in FIG. 6;

FIG. 8: shows the view according to FIG. 5 in the case of an alternative embodiment of the invention.

### DETAILED DESCRIPTION

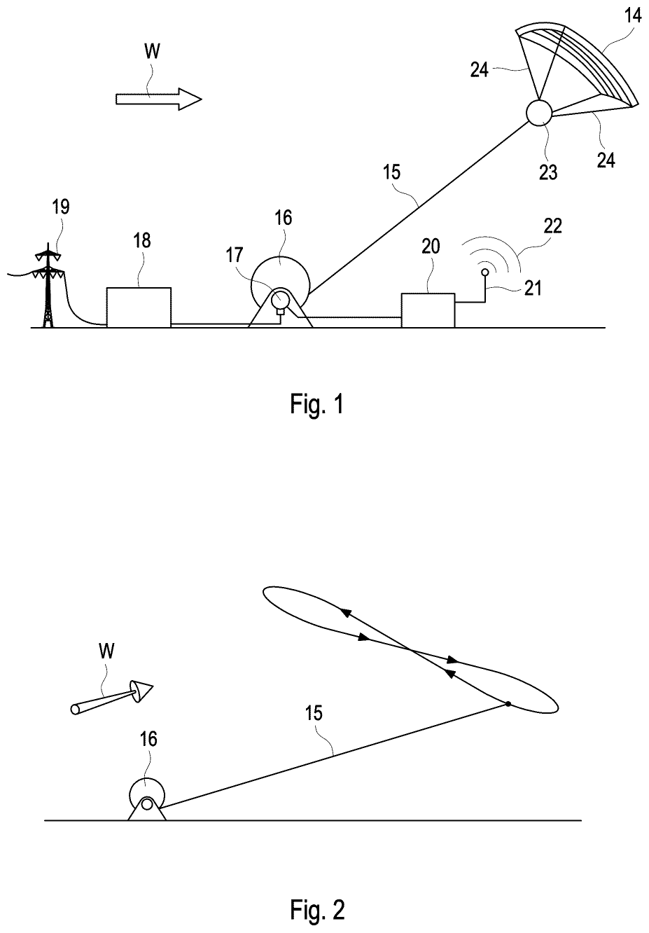

According to FIG. 1, the device according to the invention comprises a free-flying kite 14, which is connected to a traction-cable winch 16 via a traction cable 15. Coupled to the traction-cable winch 16 is an electric electrical machine 17, which operates as a generator in a first operating state and as a motor in a second operating state. The electrical machine 17 and the traction-cable winch 16 are mechanically connected to each other via a shaft 27. Alternatively, the electrical machine 17 may be coupled to the traction-cable winch 16 via a transmission.

The electrical machine is connected to a public transmission grid 19 via an electrical power train 18 comprising a converter and a transformer, such that either electrical energy generated by means of the electrical machine 17 can be fed into the transmission grid 19 or the electrical machine 17 can be operated as a motor with electrical energy extracted from the transmission grid 19. The electrical power train 18 may additionally comprise one or more energy storage devices for storing electrical energy. The device comprises a control unit 20 designed to control the interaction of the components of the device, in particular the interaction between the kite 14 and the electrical machine 17.

The control unit 20 comprises an antenna 21, such that, via a radio link 22, control signals can be exchanged with a nacelle 23 connected to the kite 14. In particular, control signals are sent from the control unit 20 to the nacelle 23 in order to control the flight path of the kite 14. By use of the control signals, the length of control lines 24 between the nacelle 23 and the kite 14 is altered, thereby influencing the direction of flight of the kite 14.

In the exemplary embodiment according to FIG. 2, the kite 14 is guided along a horizontal figure of eight aligned substantially transversely with respect to the wind direction W. While the kite 14 follows the flight path, there is exerted upon the traction cable 15 a tractive force by which the electrical machine 17 is driven via the traction-cable winch 16. By means of the electrical machine 17, which is operated as a generator in this operating state, the mechanical energy is converted into electrical energy and fed into the public transmission network 19 via the power train 18. It is also possible to store a portion of the generated energy in electrical form in an energy storage means of the power train 18.

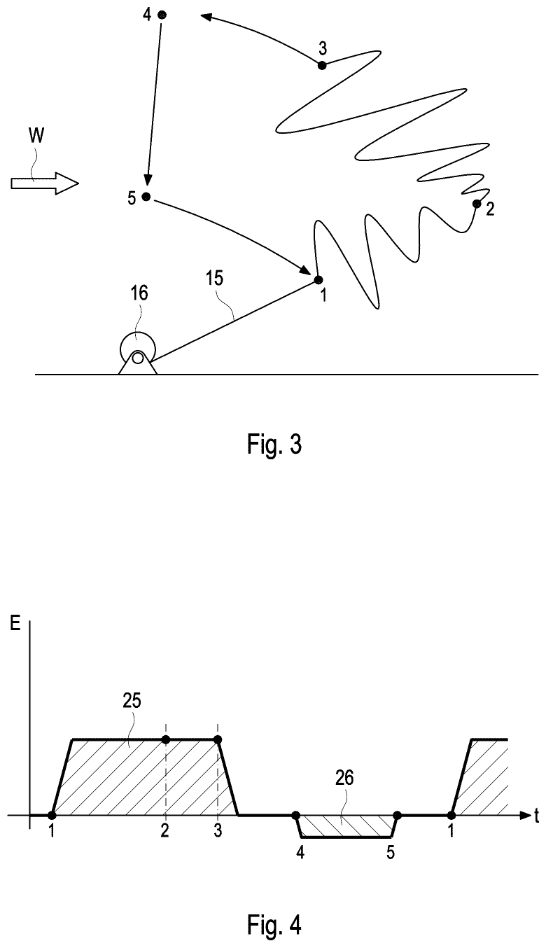

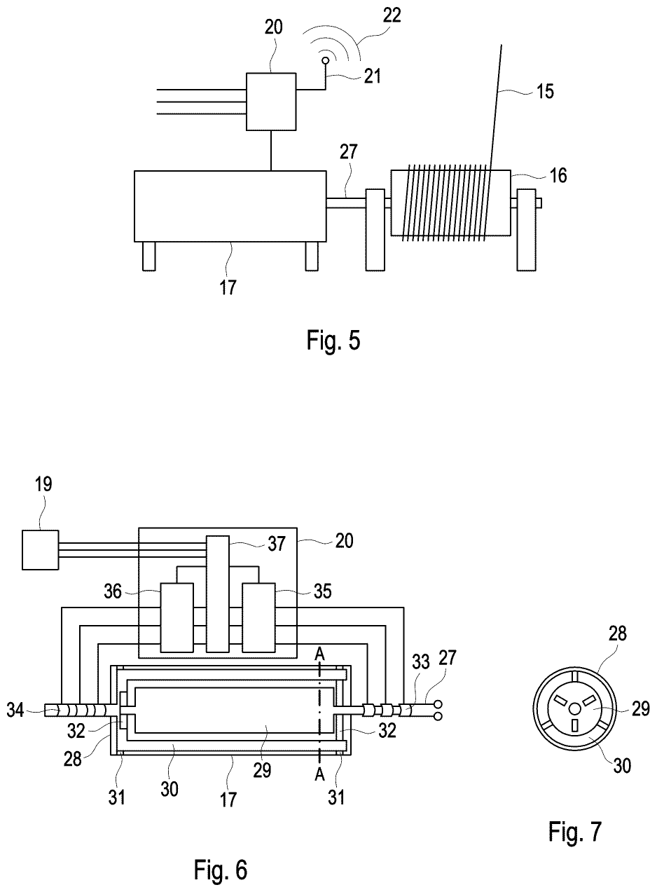

In this way, according to FIG. 3, electrical energy can be generated until the length of the traction cable 15 is exhausted and the traction cable 15 is fully paid-out from the traction-cable winch 16. The traction cable 15 must then be reeled-in before electrical energy can be generated again.

If the traction cable 15 is paid-out over its full length each time and then reeled-in to the same starting position, this results in a regular operating cycle as shown in FIG. 3. The operating cycle begins at a position 1 of the flight path. Starting from this position 1, the traction cable 15 is paid-out as the kite 14 follows its flight path and exerts a tractive force upon the traction cable 15. At a position 2, the rate of pay-out of the traction cable 15 is reduced and the movement of the kite 14 is redirected in a direction leading to a zenith position 4 vertically above the traction-cable winch 16 of the traction cable 15. At the beginning of this movement, the kite continues to be steered along flight paths on which a tractive force is exerted and electrical energy is generated. If, from a position 3, the traction-cable force is no longer sufficient to generate energy, the paying-out movement of traction cable 15 is brought to a stop and the kite is steered to the zenith position 4 vertically above the traction-cable winch 16.

When the zenith position 4 is attained, the electrical machine 17 is switched to operate as a motor and the traction cable 15 is reeled-in, by the application of energy, to position 5. From position 5, the steerable kite 10 is guided back to position 1, such that the operating cycle can begin again.

Since the traction-cable force on the way from the zenith position 4 to position 5 is less than during the previous flight paths, the energy required to reel-in the previously paid-out length of traction cable is less than the energy gained in the paying-out of the traction cable 15. The difference of the hatched area 25 in FIG. 4 and the hatched area 26 gives the amount of electrical energy E gained during an operating cycle. The hatched area 25 corresponds to the first phase 25 of an operating cycle, the hatched area 26 corresponds to the second phase 26 of an operating cycle.

According to FIG. 6, the electrical machine 17 comprises a frame 28, located in which there are a first rotor 29, realized as an internal rotor, and a second rotor 30, realized as an external rotor. The second rotor 30 is mounted, via two outer pivot bearings 3, so as to be rotatable relative to the frame 28. The first rotor 29 is mounted, via two inner pivot bearings 32, so as to be rotatable relative to the second rotor 30.

The first rotor 29 is connected to the traction-cable winch 16 via the shaft 27, such that the direction of rotation of the first rotor 29 is fixedly coupled to the operating state of the traction-cable winch 16. When the traction cable 15 is reeled-in, the first rotor 29 rotates in one direction, and when the traction cable 15 is paid-out, the first rotor 29 rotates in the opposite direction.

In contrast, the direction of rotation of the second rotor 30 is not coupled to the operating state of the traction-cable winch 16. The direction and speed of rotation of the second rotor 30 depends primarily on the electrical and magnetic forces acting between the first rotor 29 and the second rotor 30. The first rotor 29 and the second rotor 30 are each externally excited and controlled by slip rings 33, 34.

The control unit 20 comprises a first converter 35, via which electrical power can be transmitted to the first rotor 29 and received by the first rotor 29. The control unit 20 comprises a second converter 36, via which electrical power can be transmitted to the second rotor 30 and received by the second rotor 30. Electrical energy is fed into the transmission network 19 via a power train 37.

The control unit 20 controls the electrical machine 17 in such a way that, in the first phase of the operating cycle, in which the traction cable 15 is paid-out under the tractive force applied by the kite 14, a portion of the drive energy acting upon the electrical machine 17 is converted into electrical energy and fed into the transmission network 19, while another portion of the drive energy is transferred to the second rotor 30 as kinetic energy in the form of rotational energy. At the end of the first phase of the operating cycle, when the kite 14 is at the zenith position 4 above the traction-cable winch 16, the traction-cable winch 16 is stationary and the first rotor 29 is not subject to rotation. At this point in time the second rotor 30 is rotating at high speed. The electrical machine 17 is controlled by the control unit 20 in such a way that no torque is transmitted between the first rotor 29 and the second rotor 30.

At the beginning of the second phase of the operating cycle, the electrical machine 17 is controlled by the control unit 20 in such a way that a torque acts upon the first rotor 29 to drive the traction-cable winch 16 and reel-in the traction cable 15. As a result of the torque, kinetic energy is extracted from the second rotor 30, such that the rotational speed of the second rotor 30 continuously reduces as the traction cable 15 is reeled-in. At the end of the second phase of the operating cycle, both the first rotor 29 and the second rotor 30 come to a standstill. With the paying-out of the traction cable 15 under the tractive force of the kite 14, the next operating cycle begins, in which electrical energy is again fed into the transmission network 19 and the second rotor 30 is accelerated.

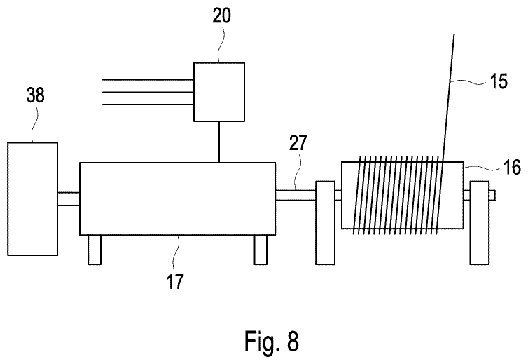

In the case of the alternative embodiment according to FIG. 8, there is a centrifugal mass 38 connected to the second rotor 30, the mass of which is significantly greater than the mass of the electrical and magnetic components of the second rotor 30. Due to the centrifugal mass 38, an increased amount of kinetic energy can be provided by means of the second rotor 30 at reduced speed.

1. A method for converting wind energy into electrical energy, in which, in a first phase (25) of an operating cycle, a kite (14) is used to exert a tractive force upon a traction-cable winch (16), and the tractive force is converted into a driving force for a power driven machine (17), such that the power driven machine (17) generates electrical energy, and in which, in a second phase (26) of the operating cycle, the power driven machine (17) is used to drive the traction-cable winch (16) to reel-in the traction cable (15), the power driven machine (17) comprising a first rotor (29), a second rotor (30) that interacts electrically with the first rotor (29), and an axial portion in which the magnetic components of the first rotor (29) overlap with the magnetic components of the second rotor (30), the first rotor (29) being mechanically coupled to the traction-cable winch (16) and, in the second phase (26) of the operating cycle, kinetic energy of the second rotor (30) being used to drive the traction-cable winch (16).

2. The method of claim 1, wherein the first rotor (29) and the second rotor (30) are externally excited rotors.

3. The method of claim 1, wherein the second rotor (30) has a higher mass than the first rotor (29).

4. The method of claim 1, wherein the second rotor (30) is an external rotor.

5. The method of claim 1, wherein the second rotor (30) is provided with a centrifugal mass (38).

6. The method of claim 1, wherein the first rotor (29) and/or the second rotor (30) is/are controlled in such a way that that the second rotor (30) is accelerated in the first phase (25) of the operating cycle.

7. The method of claim 6, wherein, in the first phase (25) of the operating cycle, an amount of kinetic energy is stored in the second rotor (30) sufficient to reel-in the traction cable (15) to an initial position (5) for the start of the next operating cycle.

8. The method of claim 6, wherein, the first phase (25) of the operating cycle, an amount of kinetic energy is stored in the second rotor (30) that is less than the energy required to reel-in the traction cable (15), and that electrical energy is supplied from an external source (19) for the purpose of reeling-in the traction cable (15).

9. The method of claim 1, wherein the power driven machine (17) is controlled in such a way that the energy feed-in is adjusted to the requirements of the transmission network (19), in that a phase of excessively high energy feed-in is counteracted by accelerating the second rotor (30), and/or in that a phase of insufficient energy feed-in is counteracted by extracting kinetic energy from the second rotor (30).

10. A device for converting wind energy into electrical energy, comprising a kite (14), comprising a traction-cable winch (16), comprising a traction cable (15) that extends between the traction-cable winch (16) and the kite (14), and comprising a control unit (20) that controls the kite (14) and a power driven machine (17), the traction-cable winch (16) being coupled to the power driven machine (17) such that, when operating as a generator, the power driven machine (17) is driven by a force acting upon the traction cable (15) to generate electrical energy, and such that, when operating as a motor, the traction-cable winch (16) is driven by the power driven machine (17) to reel-in the traction cable (15), the power driven machine (17) comprising a first rotor (29), a second rotor (30) that interacts electrically with the first rotor (29), and an axial portion in which the magnetic components of the first rotor (29) overlap with the magnetic components of the second rotor (30).

11. The device of claim 10, wherein, in a first phase (25) of an operating cycle, the control unit (20) controls the kite (14) in such a way that the kite (14) exerts a tractive force upon the traction cable (15), and that the power driven machine (17) is driven by the tractive force.

12. The device of claim 10, wherein, in a second phase (26) of an operating cycle, the control unit (20) controls the power driven machine (17) in such a way that the power driven machine (17) drives the traction-cable winch (16) by extracting kinetic energy from the second rotor (30).
